(19) United States
(12) Patent Application Publication
(10) Pub. No.: US 2009/0327981 A1
(43) Pub. Date: Dec. 31, 2009

(54) Semiconductor device or printed wiring board design method and design support system that implements settings by using a semiconductor device model that expresses parasitic elements that occur when packaged

(75) Inventors: Satoshi Nakamura, Tokyo (JP); Tsutomu Hara, Tokyo (JP); Mitsuaki Katagiri, Tokyo (JP); Yukitoshi Hirose, Tokyo (JP); Satoshi Itaya, Tokyo (JP); Ken Iwakura, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Elpida Memory, Inc., Tokyo (JP)

(21) Appl. No.: 12/457,930

(22) Filed: Jun. 25, 2009

(30) Foreign Application Priority Data
Jun. 25, 2008 (JP) 2008-165628

(51) Int. Cl. G06F 17/50

(52) U.S. Cl. 716/4; 716/15

(57) ABSTRACT

Correction circuit models are acquired for correcting electrical characteristic parameters that change upon mounting on a board. The correction circuit models are added to a separate model that represents a separate semiconductor device in isolation to create a semiconductor device model that represents the semiconductor device in a board-mounted state. An equivalent circuit model that represents an adjustment-object system is connected to the semiconductor device model that was created, and based on the semiconductor device model to which the equivalent circuit model is connected, adjustment-object values relating to the adjustment-object system are calculated. These adjustment-object values are compared with limit values that were determined in advance, and based on the results of comparison, a design guide is determined for adjusting the adjustment-object system.

### BACKGROUND OF THE INVENTION

1. Field of the Invention

The present invention relates to a design method and a design support system of a semiconductor device or a printed wiring board.

2. Description of the Related Art

In a device having a semiconductor chip, a design is necessary that keeps voltage fluctuation in the power-supply pad and/or ground pad to no greater than a permissible value. As a result, in the design stage of a device that includes a semiconductor chip, the suitability of the design of the device that includes the semiconductor chip is determined by analyzing the voltage fluctuation in the power-supply pad and/or ground pad of the semiconductor chip. Examples of a device that includes a semiconductor chip include, for example, a semiconductor package, a printed wiring board on which a semiconductor package is mounted, and any device that includes a printed wiring board on which a semiconductor package is mounted.

As an example of the above-described voltage fluctuation analysis, transient analysis was typically carried out that used a SPICE (Simulation Program with Integrated Circuit Emphasis) model. In transient analysis, when voltage fluctuation is determined to be greater than a permissible value, the layout of, for example, a semiconductor package and/or printed wiring board is corrected and the transient analysis is then carried out again. The above-described process is then repeated until the voltage fluctuation falls below the permissible value (see Patent Document 1 (JP-A-2004-54522)).

Because voltage fluctuation is analyzed each time a layout is corrected in transient analysis, the problem arises that the design time becomes lengthy as the number of layout corrections increase. As a technique for solving this problem, frequency analysis has been proposed in which, instead of transient analysis, analysis of frequency regions is carried out as in the technique disclosed in Patent Document 2 (JP-A-2005-196406).

However, the technique of Patent Document 2 takes as its object the layout on a semiconductor chip, and the technique described in Patent Document 2 is therefore difficult to apply to the design of a device that includes an already designed semiconductor chip.

In the design of a device that includes an already designed semiconductor chip, parameters that can be altered according to the results of analysis of the voltage fluctuation analysis are parts other than the semiconductor chip, more specifically, the layout of package wiring and printed wiring board. The accurate determination of whether alteration of these parameters is necessary necessitates the appropriate modeling of the semiconductor chip or semiconductor package.

For example, in a device that includes a semiconductor chip that operates as an input circuit and a semiconductor chip that operates as an output circuit, the voltage fluctuation that occurs in the power-supply pad and/or the ground pad of the output circuit was analyzed. In other words, each of a semiconductor chip, a semiconductor package for mounting a semiconductor chip, and a printed wiring board were separately modeled and the voltage fluctuation was then analyzed. It was therefore impossible to model parasitic elements that occur between the semiconductor chip and the semiconductor package or parasitic elements that occur between the semiconductor chip and/or the semiconductor package and printed wiring board. The problem therefore arose of a decrease in the accuracy of the analysis of voltage fluctuation in the power-supply pad and/or ground pad that occurs when a semiconductor chip and semiconductor package are mounted on a printed wiring board. To solve the above-described problems, models that differ from the SPICE model have been proposed, for example in Non-Patent Document 1 (lokibe Kengo, et. al “Parasitic Impedance Effects on EMC Macro-Model LECCS-core” Proceedings of Japan Institute of Electronics Packaging Annual Meeting, Vol. 21 (March 2007) 15B-02, pp. 117-119), Patent Document 3 (JP-A-2006-344111) Patent Document 4 (JP-A-2007-041867).

In Non-Patent Document 1, a semiconductor model is proposed that takes into consideration the parasitic capacitance on a board for mounting a semiconductor chip. Patent Document 3 proposes a method for appraising the parasitic elements between a semiconductor chip and a carrier substrate (package). Patent Document 4 proposes a system for analyzing the parasitic inductance that occurs in the uncoupled currents of signal current paths and return current paths that are generated in a semiconductor package in which a semiconductor chip is mounted.

However, the technology disclosed in Non-Patent Document 1 discloses only parasitic capacitance that occurs between a semiconductor chip and the substrate on which the semiconductor chip is mounted and parasitic capacitance that occurs between a semiconductor package and a printed wiring board.

The technology disclosed in Non-Patent Document 3 discloses only parasitic capacitance between a semiconductor chip and a semiconductor package. The technology disclosed in Patent Document 4 discloses only parasitic inductance that arises in uncoupled current in a semiconductor package.

### SUMMARY

In one embodiment, there is provided a semiconductor device or printed wiring board design method that includes: acquiring correction circuit models for correcting electrical characteristic parameters of a semiconductor device or a printed wiring board that change according to parasitic elements that occur between the semiconductor device and the printed wiring board when the semiconductor device is mounted on the printed wiring board; adding the correction circuit models that were acquired to a separate model that represents the semiconductor device in isolation to create a semiconductor device model that represents the semiconductor device that has been mounted on the printed wiring board; connecting to the semiconductor device model that was created an equivalent circuit model that represents an adjustment-object system in the semiconductor device or the printed wiring board that has been determined in advance; calculating adjustment-object values relating to the adjustment-object system based on the semiconductor device model to which the equivalent circuit model is connected; comparing the adjustment-object values that were calculated with limit values that were determined in advance; and based on the results of comparison, determining a design guide for adjusting the adjustment-object system.

In another embodiment, there is provided a design system that includes:

a memory unit for storing a correction circuit library that indicates, for each condition of a printed wiring board, correction circuit models for correcting electrical characteristic parameters of a semiconductor device or printed wiring board that change according to parasitic elements that occur between the semiconductor device and the printed wiring board when the semiconductor device is mounted on the printed wiring board; and
an arithmetic unit for, according to conditions of a printed wiring board on which a semiconductor device is mounted, acquiring correction circuit models from a correction circuit library that is stored in the memory unit, adding the correction circuit models that were acquired to a separate model that represents the semiconductor device in isolation to create a semiconductor device model that represents the semiconductor device mounted on the printed wiring board, connecting to the semiconductor device model that was created an equivalent circuit model that represents an adjustment-object system in the semiconductor device or the printed wiring board that was determined in advance, calculating adjustment-object values relating to the adjustment-object system based on the semiconductor device model to which the equivalent circuit model is connected, comparing the adjustment-object values that were calculated with limit values that were determined in advance, and based on the comparison results, determining a design guide for adjusting the adjustment-object system.

The above and other objects, features, and advantages of the present invention will become apparent from the following description with reference to the accompanying drawings which illustrate examples of the present invention.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram showing, in an embodiment of the present invention, a semiconductor device model in which a semiconductor device that is mounted on a printed wiring board is corrected;

FIG. 2 is a comparative view for comparing the measured values of impedance between the power supply and ground of a separate semiconductor device and measured values of impedance between the power supply and ground of a semiconductor device in a board-mounted state;

FIG. 3A is a comparative view for comparing the impedance between power supply and ground that is calculated using a separate semiconductor device model in which correction circuit models are not inserted and measured values of impedance between power supply and ground of a semiconductor device in a board-mounted state;

FIG. 3B is a comparative view for comparing the impedance between the power supply and ground that is calculated by using a semiconductor device model in which correction parameters are inserted and the measured value of impedance between the power supply and ground of a semiconductor device in a board-mounted state;

FIG. 4A is a perspective view of the semiconductor device in a board-mounted state in which a signal current and ground current are flowing;

FIG. 4B is a top view of the semiconductor device shown in FIG. 4A;

FIG. 5 is a block diagram showing a circuit for verifying the effect of the correction circuit model for correcting the effect of the uncoupled current;

FIG. 6A shows an eye pattern that was measured by the input circuit pin of a semiconductor device model in which correction circuit models for correcting the effect of uncoupled current are not inserted;

FIG. 6B shows an eye pattern that was measured by the input circuit pin of a semiconductor device model in which correction circuit models for correcting the effect of uncoupled current are inserted;

FIG. 7 is a block diagram showing an example of a semiconductor device model in which a semiconductor device that is mounted on a printed wiring board has been corrected, this semiconductor device model being specialized for the power-supply system of the input/output circuit of a semiconductor device;

FIG. 8 is a block diagram showing an example of a semiconductor device model in which a semiconductor device that is mounted on a printed wiring board has been corrected, the semiconductor device model being specialized for the signal system of an input/output circuit of a semiconductor device;

FIG. 9 is a block diagram showing an example of a semiconductor device model in which a semiconductor device that is mounted on a printed wiring board has been corrected for the power-supply system of a core circuit of a semiconductor device;

FIG. 10 is a block diagram showing an example of the configuration of a design support system;

FIG. 11 is a flow chart for explaining the flow of processes in the semiconductor device or printed wiring board design method;

FIG. 12 shows an example of a connection image of a semiconductor device model when calculating adjustment-object values;

FIG. 13 shows another example of a connection image of a semiconductor device model when calculating adjustment-object values;

FIG. 14 shows another example of a connection image of a semiconductor device model when calculating adjustment-object values;

FIG. 15 is a flow chart for explaining an example of the flow of processes for extracting a correction circuit model; and

FIG. 16 shows an example of a separate semiconductor device model.

### DETAILED DESCRIPTION OF THE PREFERRED EMBODIMENTS

Before describing of the present invention, the prior art will be explained in detail in order to facilitate the understanding of the present invention When a semiconductor device is mounted on a printed wiring board, parasitic elements are produced in at least one of the semiconductor device and printed wiring board. The semiconductor device includes a semiconductor chip or a semiconductor package in which a semiconductor chip is mounted.

In addition, examples of the above-described parasitic elements include, for example, parasitic capacitance that occurs between the printed wiring board and the semiconductor chip and/or semiconductor package, and mutual inductance or parasitic inductance that occurs between the semiconductor package and printed wiring board.

Examples of parasitic capacitance that is produced between the printed wiring board and the semiconductor chip and/or the semiconductor package include, for example, parasitic capacitance that is occurs between the ground wiring of the printed wiring board and the power-supply wiring or ground (GND) wiring of the semiconductor chip and/or semiconductor package. When the voltage fluctuation or signal waveform is analyzed without considering this parasitic capacitance, the current paths that are caused by this parasitic capacitance are overlooked and the analysis accuracy suffers.

In addition, examples of mutual inductance or parasitic inductance that occurs between the semiconductor package and printed wiring board include, for example, mutual inductance that is produced by the ground wiring of the printed wiring board and the power-supply wiring of the semiconductor package, or the parasitic inductance that is produced by the uncoupled components between the signal current and the return path current in signal wiring of the semiconductor package and/or printed wiring board. When voltage fluctuation or signal waveforms are analyzed without considering this mutual inductance and/or parasitic inductance, the effective inductance is incorrectly estimated and the analysis accuracy suffers.

Embodiments of the present invention are next described with reference to the accompanying figures. In each figure, components having the same function are given identical numbers, and redundant explanation of these functions is omitted.

Explanation first regards a semiconductor device model that corrects the electrical characteristic parameters of the semiconductor device or printed wiring board that are changed by the influence of the parasitic elements that occur between the semiconductor device and printed wiring board when the semiconductor device is mounted on the printed wiring board.

### Semiconductor Device Model

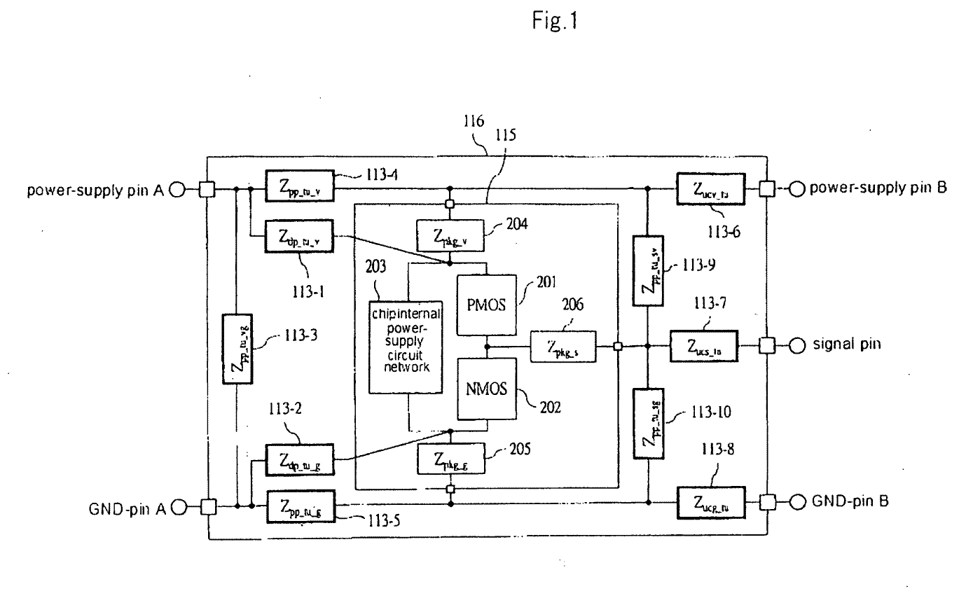

FIG. 1 is a block diagram showing a semiconductor device model of an embodiment of the present invention. In FIG. 1, semiconductor device model 116 is a model in which electrical characteristic parameters that change according to parasitic elements that occur between the semiconductor device and the printed wiring board when mounted on the board have been corrected. In FIG. 1, semiconductor device model 116 includes: separate semiconductor device model 115 that represents a semiconductor device in isolation, and correction circuit models 113 (more specifically, ten correction circuit models (113-1-113-10) for correcting electrical characteristic parameters that change in the board-mounted state in which a separate semiconductor device is mounted on a printed wiring board. In FIG. 1, separate semiconductor device model 115 represents a block that functions as the input/output circuit in a semiconductor device.

Separate semiconductor device model 115 (a block that functions as an input/output circuit) includes: an input buffer or output buffer that includes PMOS 201 and NMOS 202, a semiconductor chip that includes on-chip power supply circuit network 203, and power-supply wiring (Z_{pkg}_{_{—}}ᵥ) 204, GND wiring (Z_{pkg}_{_{—}}_{g}) 205 and signal wiring (Z_{pkg}_{_{—}}ₛ) 206 of the semiconductor package.

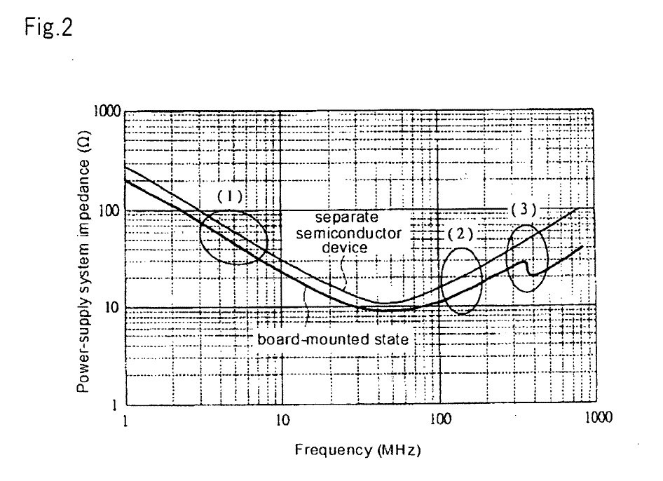

FIG. 2 is a comparative view for comparing the power-supply system (power supply-GND) impedance that is measured in the separate semiconductor device and the power-supply system impedance that is measured in the semiconductor device in a board-mounted state mounted on a printed wiring board. Here, the impedance is measured between the same power supply-GND of the same semiconductor device.

As shown in FIG. 2, regardless of the measurement of the same power supply-GND impedance in the same semiconductor device, a disparity occurs between the measurement value in the separate semiconductor device and the measurement value in the semiconductor device in the board-mounted state. This disparity shows that the electrical characteristic parameters of the semiconductor device differ for the separate semiconductor device and the semiconductor device in the board-mounted state.

The values of electrical characteristic parameters that are analyzed by using separate semiconductor device model 115 diverge from the actual values. The three areas indicated in (1)-(3) in FIG. 2 are presented as regions in which disparity occurs between the power supply-GND impedance of the separate semiconductor device and the power supply-GND impedance of the semiconductor device in the board-mounted state.

(1) Capacitance area: An area in which a disparity arises due to change of effective capacitance that results from the occurrence of parasitic capacitance in the power supply-GND wiring of a semiconductor chip or semiconductor package and the power supply-GND wiring of a printed wiring board.
(2) Induction area: An area in which a disparity arises due to change in the effective inductance that accords with the electrical/magnetic coupling between the power supply-GND wiring of a semiconductor package and the power supply-GND wiring of a printed wiring board.
(3) Resonance area: An area in which disparity arises due to a resonance characteristic resulting from parasitic parameters that are produced between a semiconductor chip or semiconductor package and a printed wiring board in the areas of the above-described (1) and (2).

In the present embodiment, the following five correction circuit models 113 are inserted in semiconductor device model 116 to correct changes in the electrical characteristic parameters that occur when mounted on a board.

The first correction circuit model 113 is chip-package/substrate power-supply wiring correction circuit model (Z_{dp}_{_{—}}ₜᵤ_{_{—}}ᵥ) 113-1 that corrects parasitic elements (for example, parasitic capacitance or mutual inductance) that occur between the power-supply wiring of a semiconductor chip and the power-supply wiring of a semiconductor package or printed wiring board.

The second correction circuit model 113 is chip-package/substrate GND wiring correction circuit model (Z_{dp}_{_{—}}ₜᵤ_{_{—}}_{g}) 113-2 that corrects parasitic elements that occur between the GND wiring of a semiconductor chip and the GND wiring of a semiconductor package or printed wiring board.

The third correction circuit model 113 is package-substrate power-supply-system correction circuit model (Zₚₚ_{_{—}}ₜᵤ_{_{—}}_{vg}) 113-3 that corrects parasitic elements that occur in the power-supply system (between power supply and GND wiring) between a semiconductor package and the printed wiring board.

The fourth correction circuit model 113 is package-substrate power-supply wiring correction circuit model (Zₚₚ_{_{—}}ₜᵤ_{_{—}}ᵥ) 113-4 that corrects parasitic elements (for example, parasitic inductance) that occur between the power-supply wiring of a semiconductor package and the power-supply wiring of a printed wiring board.

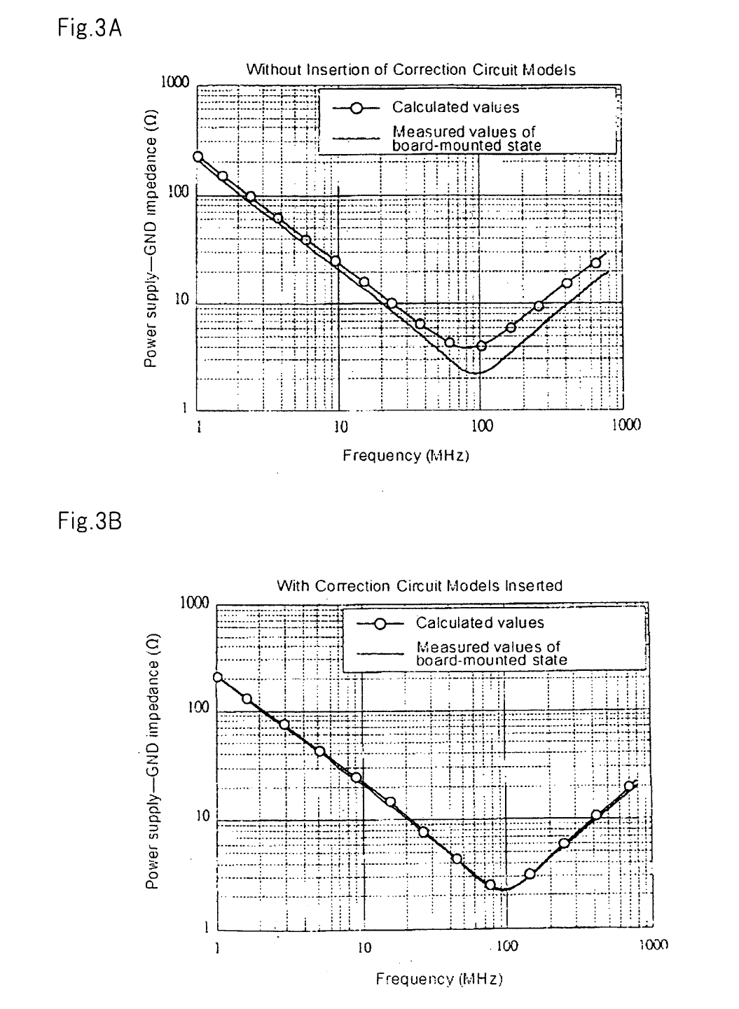

The fifth correction circuit model 113 is package-substrate GND wiring correction circuit model (Zₚₚ_{_{—}}ₜᵤ_{_{—}}_{g}) 113-5 that corrects parasitic elements (for example, parasitic inductance) that occur between the GND wiring of a semiconductor package and the GND wiring of a printed wiring board. The effect of the above-described correction circuit models 113 (correction circuit models 113-1-113-5) is next explained using FIGS. 3A and 3B.

FIG. 3A is a comparative figure for comparing calculated values that are the power supply-GND impedance that was calculated using separate semiconductor device model 115 into which the above-described correction circuit models 113 have not been inserted, and measured values that are the power supply-GND impedance that was measured in a semiconductor device that is in the board-mounted state.

As shown in FIG. 3A, the calculated values and the measured values diverge greatly. This divergence shows that the calculated values that were calculated using separate semiconductor device model 115 do not suitably represent the power supply-GND impedance in the board-mounted state. In addition, the divergence between the calculated values and the measured values is assumed to arise from the lower level of effective inductance of the power supply/GND wiring of a semiconductor package that arises from the magnetic coupling between the power supply-GND wiring of a semiconductor package and the power supply-GND wiring of a printed wiring board.

FIG. 3B is a comparative view for comparing calculated values that are the power supply-GND impedance that was calculated using a semiconductor device model in which correction circuit models 113-1 and 113-2 were inserted in separate semiconductor device model 115 and measured values that are the power supply-GND impedance that was measured by a semiconductor device in a board-mounted state.

As shown in FIG. 3B, the calculated values and measured values are in close agreement.

The foregoing explanation shows that the use of correction circuit models 113 enables semiconductor device model 116 that represents semiconductor device in a board-mounted state with good accuracy. In addition, the power supply-GND impedance characteristic is an electrical characteristic that contributes greatly to power supply noise (PI: power integrity), and the use of correction circuit models 113 can therefore be expected to improve the analysis accuracy of power supply noise.

The signal current and GND current that flow through a semiconductor device in the board-mounted state is next considered.

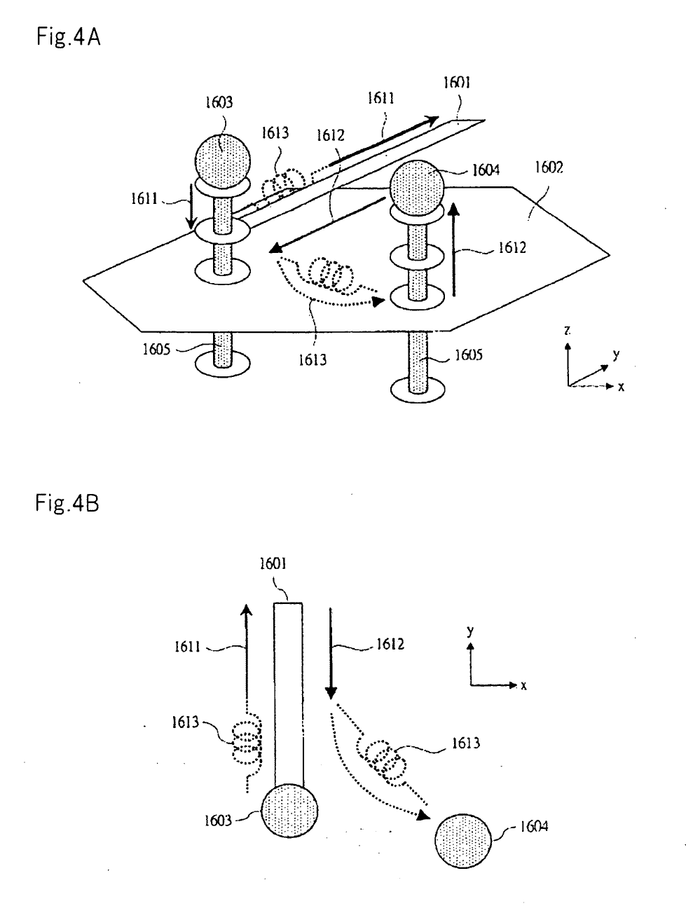

FIG. 4A is a perspective view showing a semiconductor device in the board-mounted state in which a signal current and GND current are flowing, and FIG. 4B is a top view of the semiconductor device shown in FIG. 4A.

In the printed wiring board on which a semiconductor device has been mounted, signal current 1611 is supplied from a semiconductor chip and flows to signal wiring 1601 by way of package signal wiring and package signal ball 1603. GND current 1612 that is a return current that is paired with signal current 1611 is supplied from substrate GND layer 1602 and flows to the semiconductor chip by way of package GND ball 1604 and package GND wiring. The return current is assumed to flow to substrate GND layer 1602, but may also flow to a substrate power-supply layer that is not shown in the figure.

Normally, various information is transmitted using the pair of signal current 1611 and GND current 1612. As a result, a transfer wiring model (such as micro-strip lines) in, for example, signal wiring 1601 is constructed on the assumption of the flow of the pair of signal current 1611 and GND current 1612. However, due to the conditions of the ball arrangement of a semiconductor package in an actual printed wiring board, the flow of the pair of signal current 1611 and GND current 1612 in the vicinity of the semiconductor device is extremely problematic and signal current is produced that does not form a pair. In FIGS. 4A and 4B, this signal current that does not form a pair is shown as uncoupled current (uncoupled inductor) 1613.

When signal characteristics are to be analyzed for a printed wiring board on which a semiconductor device has been mounted, the signal wiring was modeled as a transmission line model that is ideal or that has loss, and the semiconductor device was modeled as a model that represents a semiconductor device in isolation. As a result, changes in the electrical characteristics that arise from uncoupled current 1613 could not be considered, and the analysis accuracy suffered.

In the present embodiment, however, in the interest of improving the accuracy of signal analysis in a board-mounted state, the following five correction circuit models 113 are further inserted into semiconductor device model 116.

In FIG. 1, power-supply correction circuit model (Z_{ucv}_{_{—}}ₜᵤ) 113-6 for uncoupled current, signal correction circuit model (Z_{ucs}_{_{—}}ₜᵤ) 113-7 for uncoupled current, and GND correction circuit model (Z_{ucg}_{_{—}}ₜᵤ) 113-8 for uncoupled current are circuit models for correcting parasitic elements (such as parasitic inductance) that occur in each of the power-supply wiring, signal wiring, and GND wiring of the semiconductor package and/or printed wiring board due to uncoupled components of the above-described signal current and return current. In addition, package signal wiring-substrate power supply wiring correction circuit model (Zₚₚ_{_{—}}ₜᵤ_{_{—}}ₛ) 113-9 and package signal wiring-substrate GND wiring correction circuit model (Zₚₚ_{_{—}}ₜᵤ_{_{—}}ₛᵥ) 113-10 are circuit models for correcting the parasitic elements that occur between the signal wiring of the semiconductor package and the power-supply or GND wiring of the printed wiring board.

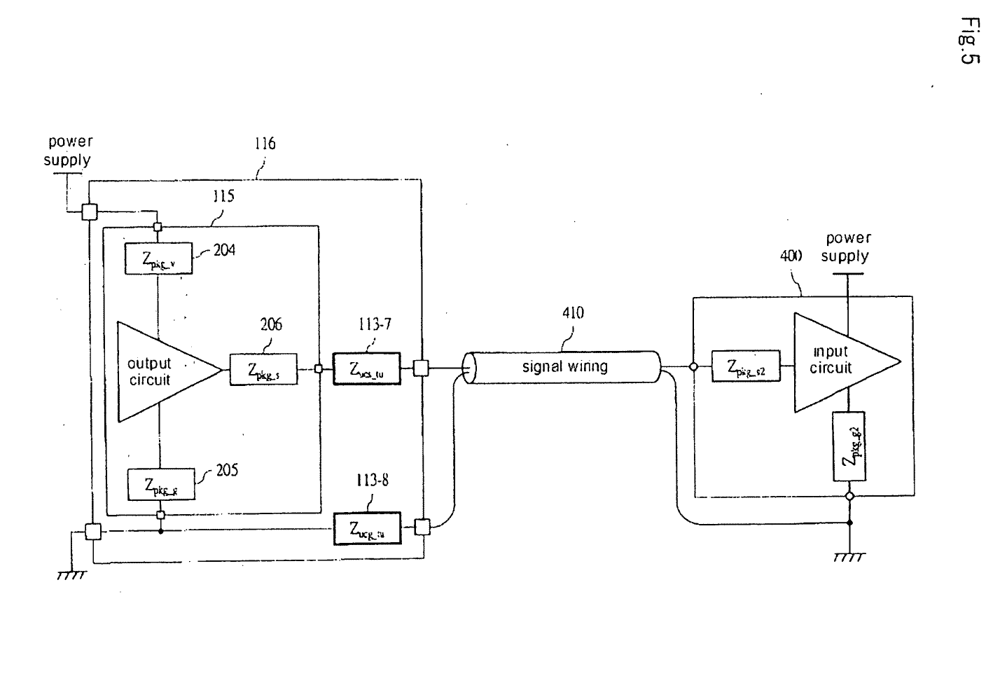

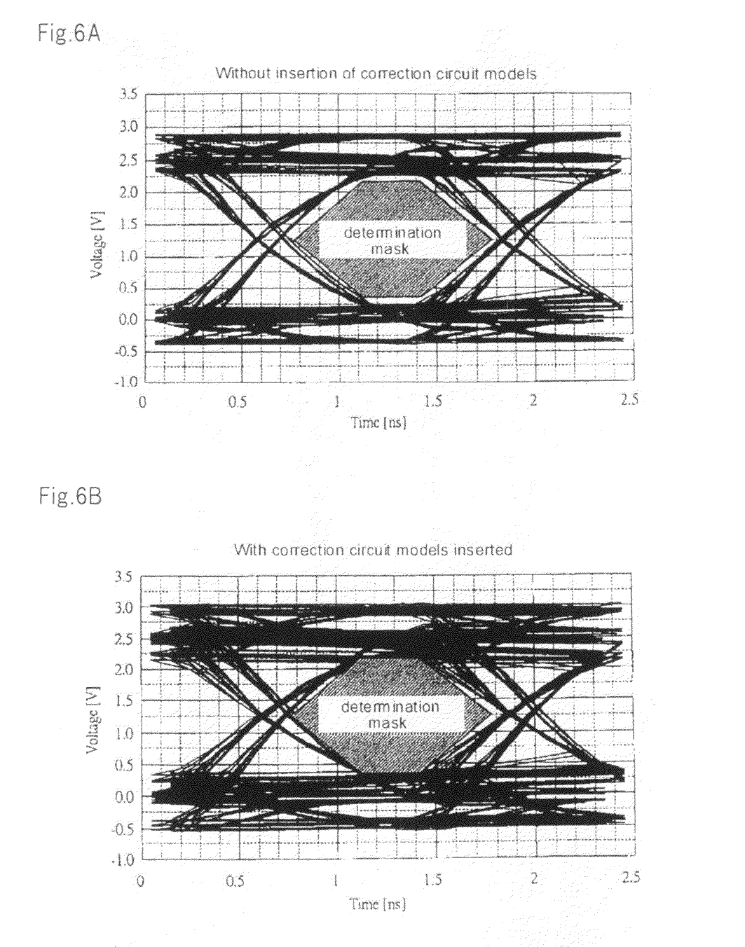

The effect of these correction circuit models 113 is next described using FIG. 5 and FIGS. 6A and 6B.

FIG. 5 is a block diagram showing the circuit for verifying the effect of correction circuit models 113 that correct the influence of uncoupled current. FIG. 5 shows semiconductor device model 116, which includes separate semiconductor device model 115 that functions as an output circuit, and signal correction circuit model (Z_{ucs}_{_{—}}ₜᵤ) 113-7 and GND correction circuit model (Z_{ucg}_{_{—}}ₜᵤ) 113-8, which are correction circuit models 113 for uncoupled current. In addition, semiconductor device model 116 has a topology that is connected with input circuit 400 by way of signal wiring (loss transmission path) 410. Signal correction circuit model (Z_{ucs}_{_{—}}ₜᵤ) 113-7 and GND correction circuit model (Z_{ucg}_{_{—}}ₜᵤ) 113-8 have inductance of 2 nH.

The signal waveform (eye pattern) that was analyzed using semiconductor device model 116 shown in FIG. 5 is compared with the signal waveform that was analyzed using separate semiconductor device model 115 in which correction circuit models 113-7 and 113-8 are eliminated from semiconductor device model 116 shown in FIG. 5.

FIG. 6A shows an eye pattern that was analyzed at the input pin of separate semiconductor device model 115, and FIG. 6B shows an eye pattern that was analyzed at the input pin of semiconductor device model 116.

When correction circuit models 113 are not inserted, the mask margin is determined to be sufficient without any portions in which the eye pattern and determination mask overlap, as shown in FIG. 6A. However, when correction circuit models 113 are inserted, the eye pattern is closed and the mask margin is determined to be insufficient with portions of overlap occurring between the determination mask and eye pattern, as shown in FIG. 6B.

As a result, when design of a semiconductor device is carried out using separate semiconductor device model 115 in which correction circuit models 113 are not inserted, the mask margin is mistakenly determined to be sufficient even though the mask margin is actually insufficient due to the influence of uncoupled current. Because the mask margin of the semiconductor device is therefore no longer adequate, the operation of the semiconductor device becomes unstable. From the foregoing explanation, it can be seen that the insertion of correction circuit models 113 for correcting the influence of uncoupled current has an important effect.

As described in the foregoing explanation, semiconductor device model 116 shown in FIG. 1 includes: separate semiconductor device model 115, correction circuit models (113-1-113-5) that are inserted in power-supply system (power supply-GND), and correction circuit models (113-6-113-10) that are inserted in the signal system. Each of these correction circuit models 113 has its own particular characteristic, but all are parameters that make a large contribution to the design quality of a semiconductor device or printed wiring board.

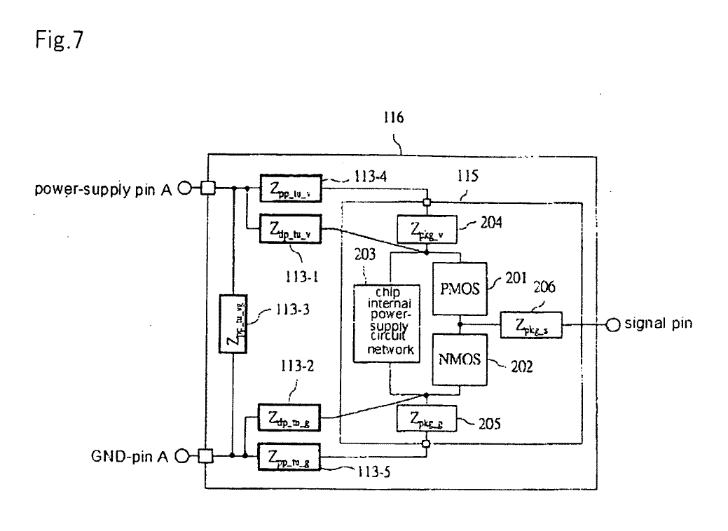

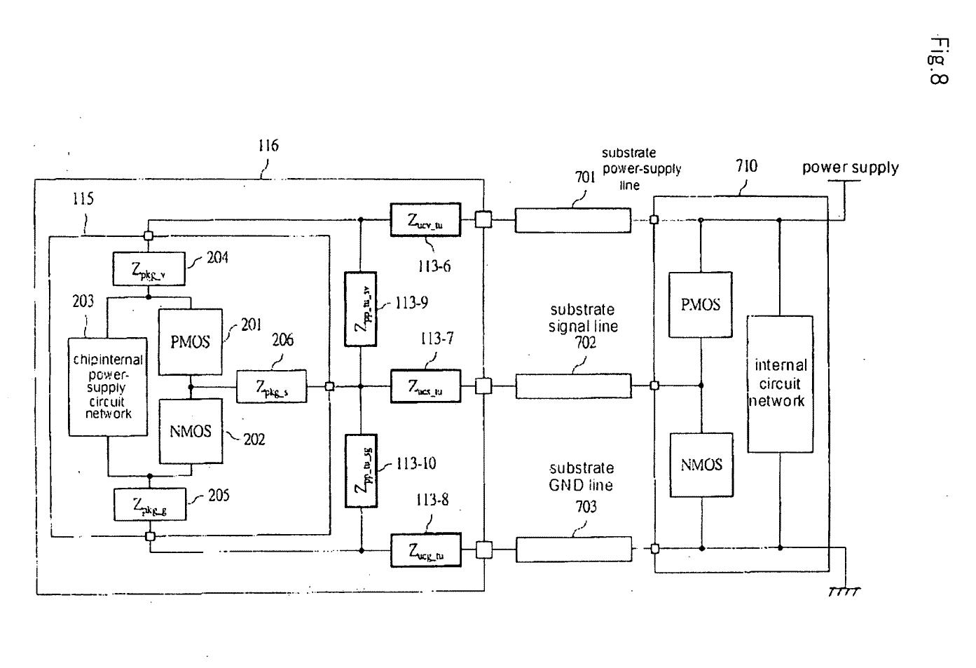

FIG. 7 is a block diagram showing an example of semiconductor device model 116 in which the electrical characteristic parameters of the power-supply system of the input/output circuits of a semiconductor device have been corrected. FIG. 8 is a block diagram showing an example of semiconductor device model 116 in which the electrical characteristic parameters of the signal system of the input/output circuit of a semiconductor device have been corrected. In FIG. 8, semiconductor device 710 is a semiconductor device in which semiconductor device model 116 carries out input/output. Semiconductor device 710 is connected to semiconductor device model 116 by way of substrate power-supply line 701, substrate signal line 702, and substrate GND line 703.

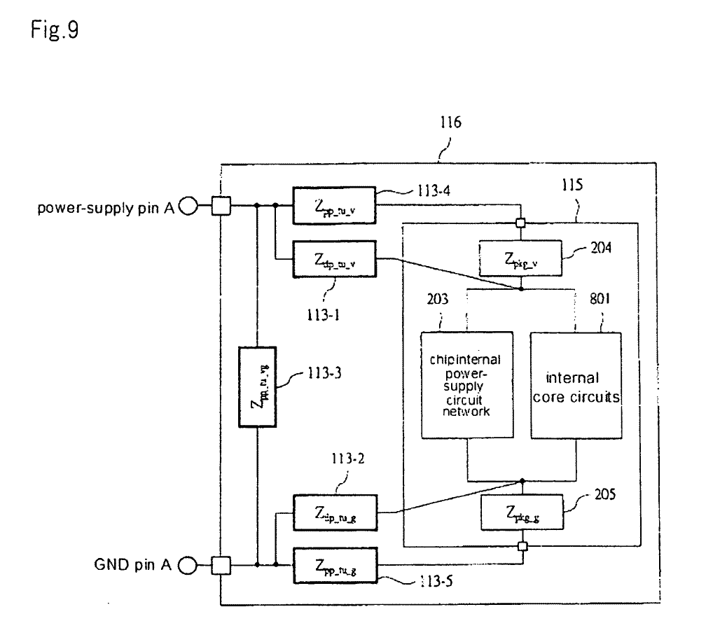

Varying the use of each of semiconductor devices 116 shown in FIG. 7 and FIG. 8 as appropriate allows the appraisal of power-supply system noise and appraisal of the signal quality of the signal system to be carried out separately. FIG. 9 is a block diagram showing an example of semiconductor device model 116 in which the electrical characteristic parameters of the power-supply system of a core circuit of the semiconductor device have been corrected in the semiconductor device model shown in FIG. 1. In semiconductor device model 116 of FIG. 9, internal core circuit 801 basically does not carry out input/output of signals with the outside, and correction circuit models (113-6-113-10) that relate to uncoupled current are therefore unnecessary. However, correction circuit models (113-6-113-10) relating to uncoupled current may be inserted when input/output circuits are connected to the power-supply system of internal core circuit 801.

In addition, not all of correction circuit models 113 shown in FIG. 1 and FIGS. 7-9 are necessary, and only a portion of correction circuit models 113 may be inserted.

Correction circuit models 113 can be found from the electrical characteristics (such as power supply-GND impedance and signal-GND transmission characteristics) that were actually measured on a printed wiring board in which a semiconductor device is mounted and from the electrical characteristics of separate semiconductor device model 115. The electrical characteristics of separate semiconductor device model 115 can be found by means of analysis (simulation) of separate semiconductor device model 115, can be found by measurement in a separate semiconductor device, and can also be acquired from the semiconductor maker. Details regarding the method of extracting correction circuit models 113 will be explained hereinbelow.

By constructing a database (library) of correction circuit models 113 for each condition (such as layer configuration, layer thickness, substrate thickness, and substrate layer thickness) of a printed wiring board in which a semiconductor device has been mounted, suitable correction circuit models 113 can be inserted into separate semiconductor device model 115 according to the printed wiring board to enable construction of optimum semiconductor device model 116. This creation of a database of correction circuit models 113 enables the establishment of a design method of a semiconductor device or a printed wiring board that uses semiconductor device models 116 into which correction circuit models 113 have been inserted, or enables the construction of a design support system for realizing such a design method.

Design Method or Design Support System for a Semiconductor Device or Printed Wiring Board

The following explanation regards a semiconductor device or printed wiring board design method that uses semiconductor device models 116 and a design support system for realizing such a design method.

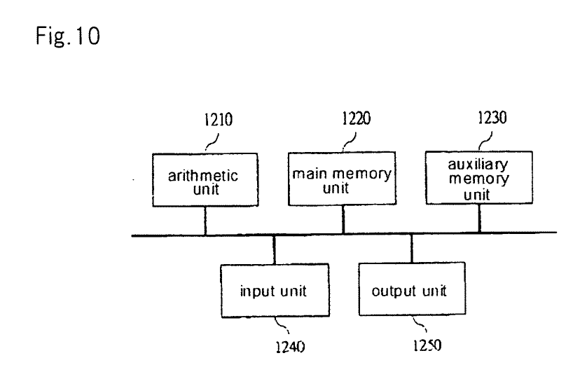

FIG. 10 is a block diagram showing the configuration of the design support system of the present embodiment.

In FIG. 10, the design support system is, for example, a computer system and includes: arithmetic unit 1210, main memory unit 1220, auxiliary memory unit 1230, input unit 1240, and output unit 1250.

Arithmetic unit 1210 is made up from a computer such as a CPU. Main memory unit 1220 is made up by a memory device such as DRAM, and auxiliary memory unit 1230 is made up from, for example, a memory medium such as a HDD or CD-ROM. In addition, input unit 1240 is made up by an input device such as a keyboard or mouse, and output unit 1250 is made up from, for example, a display device such as a CRT or liquid crystal display or a printing device such as a printer.

In addition, auxiliary memory unit 1230 stores a design support program for causing a computer to execute the semiconductor device or printed wiring board design method that is described hereinbelow. Arithmetic unit 1210 reads the design support program that is stored in auxiliary memory unit 1230, and by expanding this design support program that has been read in main memory unit 1220 and then executing the program, executes the semiconductor device or printed wiring board design method.

The various types of information (111-119) for realizing the design method are set (stored) in advance in auxiliary memory unit 1230. In addition, main memory unit 1220 also temporarily stores data that are generated while arithmetic unit 1210 is executing the design support program and data that are read from auxiliary memory unit 1230 and that are used by arithmetic unit 1210. Although main memory unit 1220 and auxiliary memory unit 1230 are of independent construction in FIG. 10, main memory unit 1220 and auxiliary memory unit 1230 may also be treated as a unified memory unit. Alternatively, the design support system may include a network interface that can access the memory unit of another computer system such as a file server or database server, or may have a configuration that can execute at least a portion of the semiconductor device or printed wiring board design method in accordance with a request from a client terminal and then return the execution result to the client terminal.

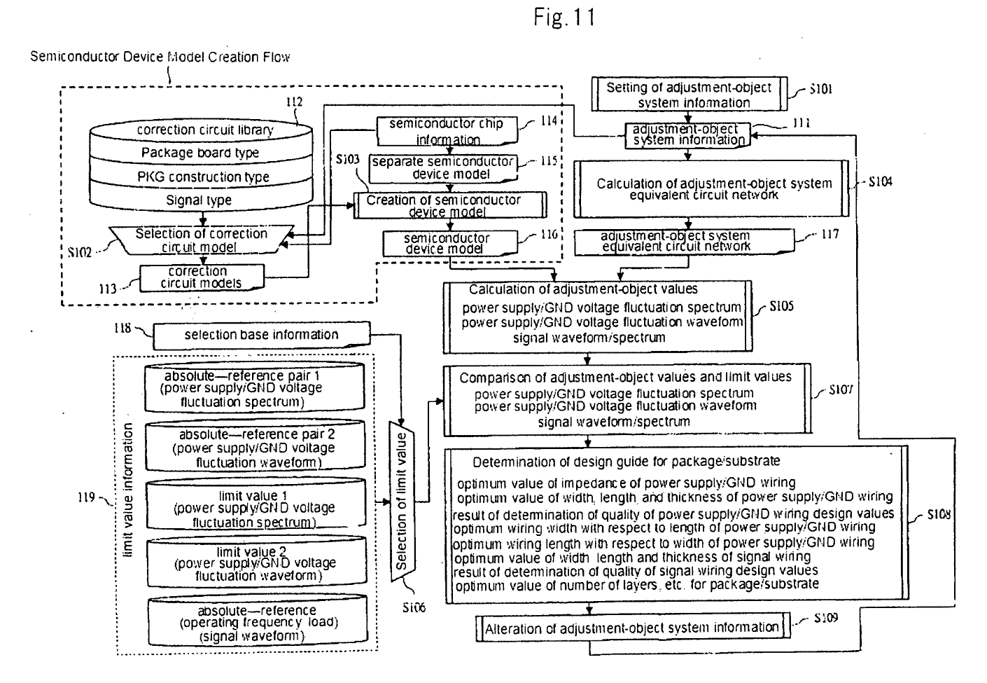

FIG. 11 is flow chart for explaining the flow of processes in the semiconductor device or printed wiring board design method.

Sites in a semiconductor package and printed wiring board that are adjusted for optimizing the design of a semiconductor device or printed wiring board are hereinbelow referred to as the adjustment-object system. In addition, the adjustment-object system is determined in advance and is, for example, the power supply-GND wiring and signal wiring of a semiconductor package or the power supply-GND wiring and signal wiring of a printed wiring board. Information relating to a semiconductor package and information relating to a printed wiring board are first set in auxiliary memory unit 1230 as adjustment-object system information 111 that relates to the adjustment-object system (Step S101).

The information shown below is offered as an example of the information relating to a semiconductor package and the information relating to a printed wiring board.

### Information Relating to a Semiconductor Package

Number and types of mounted chips (for example, one chip or a plurality of chips)
Chip-mounting type (for example, wire-bonding mounting or flip-chip mounting)
Package type (for example, BGA (Ball Grid Array) or lead-frame and substrate material)
Package construction (for example, number of substrate layers and layer configuration)

### Information Relating to a Printed Wiring Board

Printed wiring board construction (for example, number of layers, layer configuration, etc.)
Printed wiring board type (for example, via type, substrate material, etc.)

Arithmetic unit 1210 next, based on adjustment-object system information 111 that was set in Step S101, executes a semiconductor device model production flow (Steps S102 and S103) for creating a semiconductor device model that corrects electrical characteristic parameters that change in the board-mounted state when a semiconductor device is mounted on a printed wiring board.

In the semiconductor device model production flow, arithmetic unit 1210 first, based on adjustment-object system information 111 that was set in Step S101 and semiconductor chip information 114 that was stored in advance in auxiliary memory unit 1230, acquires correction circuit models 113 that are to be used in semiconductor device model 116 from correction circuit library 112 that has been stored in advance in auxiliary memory unit 1230 (Step S102).

Semiconductor chip information 114 is information relating to a semiconductor chip, and is, for example, information relating to:
Semiconductor chip type (such as memory, microprocessor)
Object circuits in the semiconductor chip (such as input/output circuit, core circuit, power-supply system circuits, etc.)

The process for acquiring correction circuit models 113 will be explained in detail hereinbelow.

Arithmetic unit 1210 next adds the correction circuit models that were acquired in Step S102 to separate semiconductor device model 115 that was determined according to semiconductor chip information 114, whereby semiconductor device model 116 that represents a semiconductor device in a board-mounted state in which the changes in electrical characteristic parameters when mounted on a board have been corrected, i.e., semiconductor device model 116 is produced in which the correction circuit models 113 have been inserted as shown in FIG. 1 and FIGS. 7-9 (Step S103).

In this case, semiconductor chip information 114 is information relating to a semiconductor chip, and is, for example, information relating to:
Semiconductor chip type (such as memory, microprocessor, etc.)
Object circuits in the semiconductor chip (such as input/output circuit, core circuits, power-supply system circuits, etc.)

Arithmetic unit 1210 then implements the design of a device that includes a semiconductor device in a state mounted on a printed wiring board based on semiconductor device model 116 produced in the semiconductor device model production flow. This process is described hereinbelow.

Arithmetic unit 1210 first, based on adjustment-object system information 111 that was set in Step S101, generates adjustment-object system equivalent circuit network 117, which is an equivalent circuit that represents the adjustment-object system (Step S104). Here, adjustment-object system equivalent circuit network 117 is, for example, a lumped-constant equivalent circuit, a distributed-constant equivalent circuit, or an impedance model of the power-supply system and/or signal system of a printed wiring board, which is the adjustment-object system.

Arithmetic unit 1210 next connects adjustment-object system equivalent circuit network 117 that was created in Step S104 to semiconductor device model 116 that was created in Step S103 and uses semiconductor device model 116 to which the adjustment-object system equivalent circuit network 117 is connected to calculate the adjustment-object values relating to the adjustment-object system (Step S105). The adjustment-object values are the power supply-GND voltage fluctuation spectrum or power supply/GND voltage fluctuation waveform, and the signal spectrum or signal waveform.

The voltage fluctuation spectrum expresses the voltage fluctuation by frequency regions, and the voltage fluctuation waveform expresses the voltage fluctuation by time regions. In addition, the signal spectrum expresses the signal by frequency regions, and the signal waveform expresses the signal by time regions.

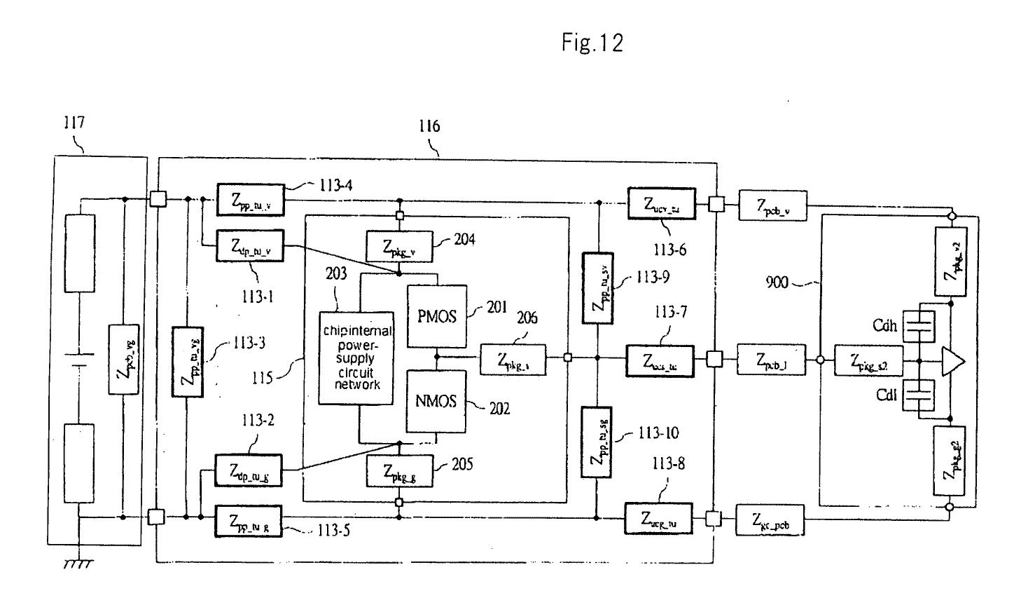

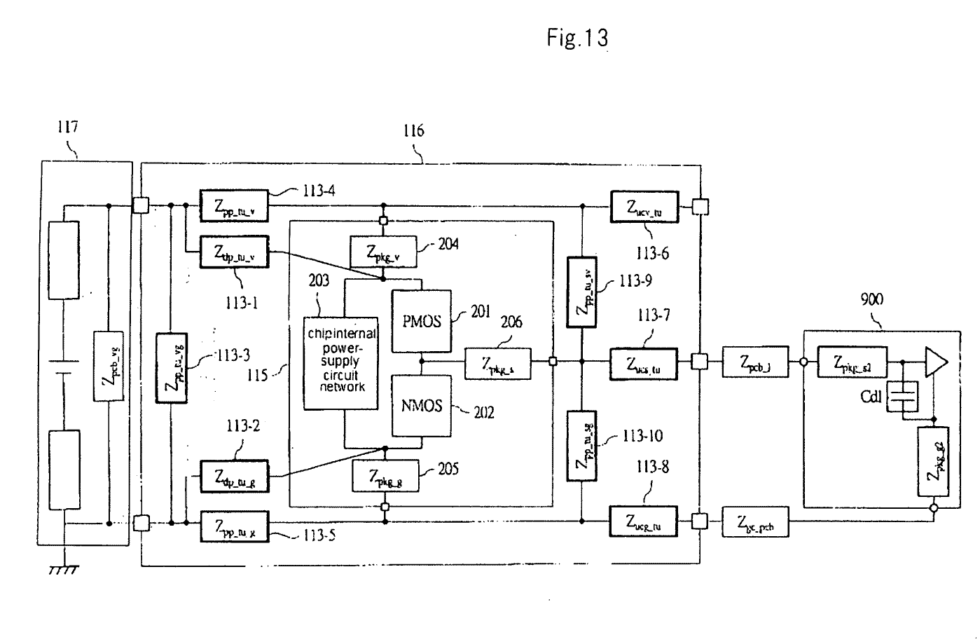

FIGS. 12-14 show connection images of semiconductor device model 116, in which the board-mounted state is corrected, when the adjustment-object values are calculated in Step S105. In FIGS. 12-14, semiconductor device model 116 is connected to adjustment-object system equivalent circuit network 117. In addition, in FIGS. 12 and 13, semiconductor device model 116 is connected to input circuit 900, and semiconductor device model 116 shown in FIG. 1 or FIGS. 7 and 8 may be used as semiconductor device model 116.

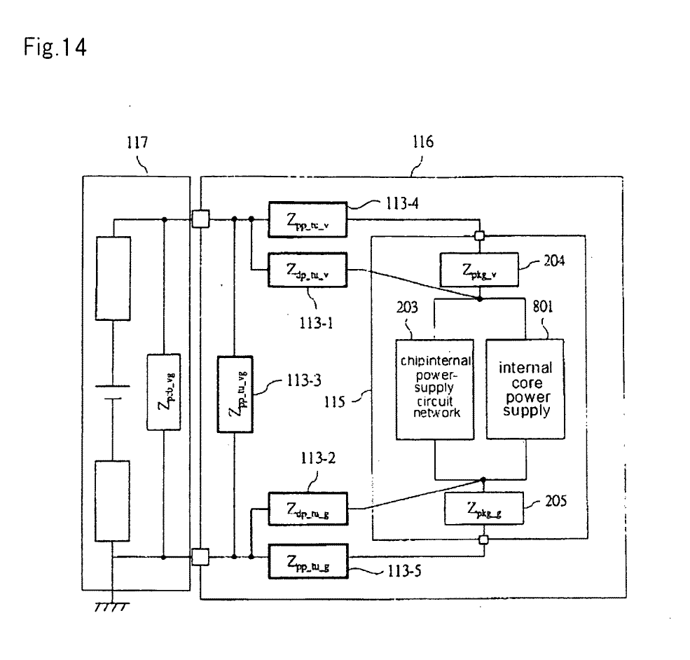

In FIGS. 12 and 13, the method of expressing input circuit 900 differs. In FIG. 12, input circuit 900 in which static protection capacitances (Cdh and Cdl) are inserted at the power-supply and GND sides, respectively, is used; and in FIG. 13, input circuit 900 in which static protection capacitance (Cdl) is inserted only on the GND side is used. Input circuit 900 shown in FIG. 12 should be used when a return current opposite the signal current flows to both the power supply and GND, and input circuit 900 shown in FIG. 13 should be used when a return current opposite the signal current flows only to the GND side, i.e., when the power supply is separated in the output circuit and input circuit. In FIG. 14, semiconductor device model 116 that represents the core circuit shown in FIG. 9 is used. As described hereinabove, a core circuit basically does not have input or output of signals with the outside and signal wiring is therefore not necessary.

The power supply-GND voltage fluctuation spectrum or signal spectrum can be calculated by solving the closed circuit equations that correspond to each closed circuit of the connection image figures shown in FIGS. 12-14. At this time, the closed-circuit equations to be solved may be simplified by considering whether there are sites that are viewed as short-circuited or sites that are viewed as open based on the size relation of the impedance of each closed circuit. In addition, the power supply-GND voltage fluctuation waveform or signal waveform, which is time region information, may be calculated by subjecting the power supply-GND voltage fluctuation spectrum or signal spectrum that was found as described above to an inverse Fourier transform. In addition, the power supply-GND voltage fluctuation waveform or signal waveform may be calculated by simply carrying out a transient analysis by means of the circuit analysis formula such as SPICE based on the circuit diagrams of FIGS. 12-14.

Arithmetic unit 1210 next, based on selection base information 118 that was stored in advance in auxiliary memory unit 1230, selects from limit value information 119 that was stored in advance in auxiliary memory unit 1230 the limit value for the adjustment-object values that were calculated in Step S105 (Step S106).

Selection base information 118 shows the packaging/operating conditions that indicate the operating frequency or load of a semiconductor device or printed wiring board. Limit value information 119 shows, for each packaging/operating condition, values that serve as the references for the power supply-GND voltage fluctuation spectrum or voltage fluctuation waveform and for the signal spectrum or signal waveform in a semiconductor device or printed wiring board that is suitable for that packaging/operating condition; or values that serve as references for the power supply-GND voltage fluctuation spectrum or voltage fluctuation waveform and for the signal spectrum or signal waveform that are measured or analyzed using the same semiconductor device or printed wiring board as the packaging/operating condition.

Arithmetic unit 1210 next compares the adjustment-object values that were calculated in Step S105 with the limit values that were selected in Step S106 (Step S107). Arithmetic unit 1210 then, based on the results of comparison, determines a design guide for adjusting the adjustment-object system of the semiconductor package or printed wiring board (Step S108).

Examples that can be offered as the design guide in a semiconductor package or printed wiring board include:

1) the optimum value of power supply/GND wiring impedance
2) the optimum values of the design values of power supply/GND wiring (width, length, thickness)
3) the results of quality determination of the design values of power supply/GND wiring
4) the optimum wiring width with respect to length of power supply/GND wiring
5) the optimum wiring length with respect to width of power supply/GND wiring
6) the optimum values of design values (width, length, thickness) of signal wiring
7) the results of quality determination of the design values of signal wiring
8) the optimum values of layer number and layer configuration of the semiconductor package/printed wiring board

Upon determining the design guide in Step S108, arithmetic unit 1210 alters adjustment-object system information 111 in accordance with the design guide (Step S109). Then, arithmetic unit 1210 may again execute Steps S102-S108 based on this altered adjustment-object system information 111. The optimum values in the design guide may be found by carrying out a process of repeating Steps S102-S108 in this way. Even when adjustment-object system information 111 is altered in Step S109, the semiconductor device model production flow of Steps S102-S103 in this repetition process may be omitted if the prerequisite conditions for selecting correction circuit models 113 in Step S102 do not change greatly.

In addition, upon determining the design guide in Step S108, arithmetic unit 1210 may also supply this design guide from output unit 1250 to present to the user.

### Method of Acquiring Correction Circuit Models 113

The method of acquiring correction circuit models 113 that is carried out in Step S102 is next explained in detail.

Correction circuit models 113 can be found based on electrical characteristic parameters (such as power supply-GND impedance and signal-GND transmission characteristics) that were measured in a printed wiring board in which a semiconductor device is packaged and on electrical characteristic parameters of separate semiconductor device model 115 that were acquired from analysis (simulation), measurement, or from the semiconductor maker. In addition, optimum semiconductor device model 116 can be constructed by storing, for each condition of a printed wiring board on which a semiconductor device is mounted (such as the layer configuration, layer thickness, substrate thickness, and substrate layer thickness), in auxiliary memory unit 1230 in advance a library that indicates correction circuit models 113 that are suitable to the conditions.

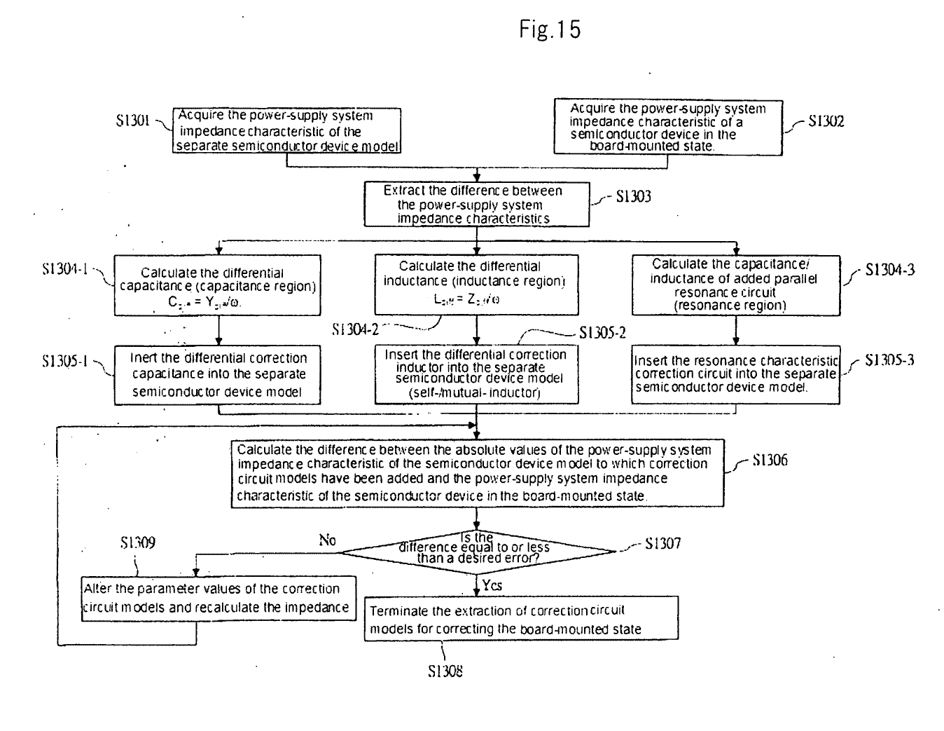

FIG. 15 is a flow chart for explaining the flow of processes of acquiring correction circuit models 113.

Arithmetic unit 1210 first acquires the power-supply system impedance characteristics of separate semiconductor device model 115 that were stored in advance in auxiliary memory unit 1230 (Step S1301).

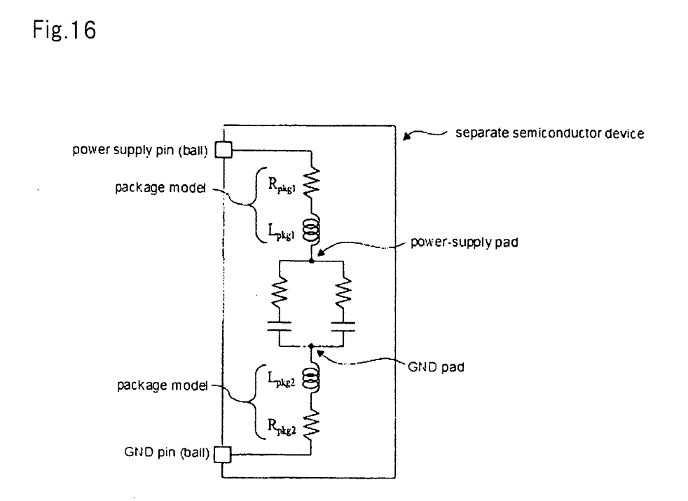

The power-supply system impedance characteristics are values in which the power supply-GND impedance is expressed by frequency regions, and these may be values that are actually measured, values that are calculated through simulation, or values that are acquired from a semiconductor vendor. Separate semiconductor device model 115 is a circuit block expressed by linear elements such as RLC as shown in FIG. 16.

Arithmetic unit 1210 next acquires the power-supply system impedance characteristic of the semiconductor device in a board-mounted state that was stored in advance in auxiliary memory unit 1230 (Step S1302).

The power-supply system impedance characteristic of a semiconductor device in a board-mounted state is a value that is actually measured using a semiconductor device that is mounted on a printed wiring board. The printed wiring board at this time may be a manufactured printed wiring board that actually packages a semiconductor device, or may be a standard printed wiring board that has been produced for testing. In addition, the power-supply system impedance characteristic of a semiconductor device in the board-mounted state may be a value calculated using, for example, electromagnetic field analysis software that can analyze the mutual coupling between a semiconductor chip die, package, and a printed wiring board.

When building a library (when creating a database) of correction circuit models 113, the assumed packaging conditions when a semiconductor device is packaged on a printed wiring board may be imitated. For example, a plurality of types of standard printed wiring boards may be produced and the power-supply system impedance then measured with a semiconductor device mounted on each of these printed wiring boards. The types of printed wiring boards may be categorized based on information, as in:

### Information Relating to Printed Wiring Boards:

Printed wiring board construction (such as number of layers and layer configuration)
Printed wiring board types (such as the types of vias or the substrate material)

Arithmetic unit 1210 next calculates the difference between the power-supply system impedance characteristics that were acquired in Step S1301 and Step S1302 (Step S1303).

The regions for which differences are calculated can take as targets the three following regions: (1) capacitance region, (2) inductance region, and (3) resonance region in which there is a difference between two impedance characteristics in FIG. 2. Although a case of an impedance characteristic is described in the present embodiment in which each region appears in the order (1)→(2)→(3) as shown in FIG. 2, this acquisition method can be applied even in an impedance characteristic in which each region appears in random order.

The capacitance region is a region in which the absolute value of the impedance characteristic steadily declines, and moreover, in which the phase is a negative value (in the vicinity of from −50° to −90°). The inductance region is a region in which the absolute value of the impedance characteristic continuously increases, and moreover, in which the phase is a positive value (in the vicinity of from +50° to +90°). In addition, the resonance region is a region in which the absolute value of the impedance characteristic is close to its minimum value, and moreover, in which the phase is close to 0° (in the vicinity of from 0° to ±20°).

Arithmetic unit 1210 next calculates the parameters of correction circuits based on the difference in impedance characteristics that was calculated in Step S1303.

More specifically, in the capacitance region, arithmetic unit 1210 calculates differential capacitance C_{diff} by substituting admittance differential Y_{diff} in any angular frequency ω in formula 1 (Step S1304-1).

$${C}_{diff} = \frac{{Y}_{diff}}{ω} \qquad [ Formula 1 ]$$

Here, angular frequency ω is represented by ω=2πf if the frequency is f. In addition, the admittance differential Y_{diff} is the difference between the reciprocal of the power-supply system impedance of separate semiconductor device model 115 and the reciprocal of the power-supply system impedance of the semiconductor device in the board-mounted state.

Arithmetic unit 1210 adds the circuit for correcting the differential capacitance C_{diff} to separate semiconductor device model 115 as the differential correction capacitance (Step S 1305-1). More specifically, arithmetic unit 1210 inserts differential correction capacitance between the package power supply-GND pin and chip power supply-GND pad of separate semiconductor device model 115 as chip-package/substrate power-supply wiring correction circuit model (Z_{dp}_{_{—}}ₜᵤ_{_{—}}ᵥ) 113-1, chip-package/substrate GND wiring correction circuit model (Z_{dp}_{_{—}}ₜᵤ_{_{—}}_{g}) 113-2, and/or package-substrate power-supply system correction circuit model (Zₚₚ_{_{—}}ₜᵤ_{_{—}}_{vg}) 113-3.

In the inductance region, arithmetic unit 1210 calculates differential inductance L_{diff} by substituting impedance differential Z_{diff} in any angular frequency ω into formula 2 (Step S1304-2).

$${L}_{diff} = \frac{{Z}_{diff}}{ω} \qquad [ Formula 2 ]$$

Here, impedance differential Z_{diff} is the difference between the power-supply system impedance of separate semiconductor device model 115 and the power-supply system impedance of a semiconductor device in the board-mounted state.

Arithmetic unit 1210 adds a circuit for correcting differential inductance L_{diff} to separate semiconductor device model 115 as the differential correction inductor (Step S1305-2).

More specifically, when the inductance of separate semiconductor device model 115 must be increased, arithmetic unit 1210 inserts differential correction inductor in a series into the package power supply/GND wiring portion as package-substrate power-supply wiring correction circuit model (Zₚₚ_{_{—}}ₜᵤ_{_{—}}ᵥ) 113-4 and/or package-substrate GND wiring correction circuit model (Zₚₚ_{_{—}}ₜᵤ_{_{—}}_{vg}) 113-5. Alternatively, when the inductance of separate semiconductor device model 115 must be decreased, arithmetic unit 1210 may insert differential correction inductor in parallel into the package power supply/GND wiring portion as chip-package/substrate power-supply wiring correction circuit model (Z_{dp}_{_{—}}ₜᵤ_{_{—}}ᵥ) 113-1 and/or chip-package/substrate GND wiring correction circuit model (Z_{dp}_{_{—}}ₜᵤ_{_{—}}_{g}) 113-2, or may insert differential correction inductor between the power-supply wiring and the GND wiring of a printed wiring board as package-substrate power-supply system correction circuit model (Zₚₚ_{_{—}}ₜᵤ_{_{—}}_{vg}) 113-3.

In a resonance region, arithmetic unit 1210 specifies the parameter (resonance frequency f₀) of a parasitic element that occurs and resonates when a semiconductor device is packaged on a printed wiring board. Arithmetic unit 1210 substitutes this resonance frequency f₀ in a formula of the resonance frequency of the RLC serial resonance circuit shown in formula 3 to calculate the value of capacitance C or inductance L in the resonance region (Step S1304-3).

$${f}_{0} = \frac{1}{2 π \sqrt{LC}} \qquad [ Formula 3 ]$$

Here, the value of either capacitance C or inductance L must be uniquely determined in advance. In the present embodiment, an inductance region appears after the resonance frequency, and arithmetic unit 1210 therefore calculates the inductance value in this inductance region as inductance L and then uses this inductance L to calculate capacitance C of the resonance region. Arithmetic unit 1210 adds a resonance circuit that expresses the resonance region to separate semiconductor device model 115 as a resonance characteristic correction circuit (Step S1305-3). More specifically, arithmetic unit 1210 may insert an RLC series circuit between the chip power supply/GND pad and the package power supply/GND pin as chip-package/substrate power-supply wiring correction circuit model (Z_{dp}_{_{—}}ₜᵤ_{_{—}}ᵥ) 113-1, chip-package/substrate GND wiring correction circuit model (Z_{dp}_{_{—}}ₜᵤ_{_{—}}_{g}) 113-2, package-substrate power-supply wiring correction circuit model (Zₚₚ_{_{—}}ₜᵤ_{_{—}}ᵥ) 113-4, and/or package-substrate GND wiring correction circuit model (Zₚₚ_{_{—}}ₜᵤ_{_{—}}_{g}) 113-5; or may insert an RLC series circuit in parallel between package power supply pins and GND pins as package-substrate power-supply system correction circuit model (Zₚₚ_{_{—}}ₜᵤ_{_{—}}_{vg}) 113-3.

Although the present embodiment regards a flow for acquiring correction circuit models 113 in all of the following regions of (1) capacitance region, (2) inductance region, and (3) resonance region, correction circuit models 113 need not be acquired in all regions. For example, when a divergence is observed in the impedance characteristic in only a capacitance region, Steps S1304-2 and S1304-3, and Steps S1305-2 and S1305-3 need not be executed. Arithmetic unit 1210 next calculates the power-supply system impedance characteristic of semiconductor device model 116 to which correction circuit models 113 were added in Steps S1305-1-3 and calculates the difference between the absolute value of the power-supply system impedance characteristic and the absolute value of the power-supply system impedance characteristic of the semiconductor device in the board-mounted state (Step S1306).

Arithmetic unit 1210 next determines whether the difference calculated in Step S1306 is no greater than a predetermined error (Step S1307).

If the difference is no greater than the predetermined error, arithmetic unit 1210 ends the acquisition of correction circuit models 113 for correcting the board-mounted state (Step S1308).

On the other hand, when the error is greater than the predetermined error, arithmetic unit 1210 alters the parameter values of correction circuit models 113 and again calculates the impedance characteristic (Step S1309) and repeats the series of processes of Steps S1306→S1307→S1309→S1306 until the difference falls to or below the predetermined error.

The predetermined error, which is the determination standard in Step S1307, can be determined in accordance with the analysis accuracy, such as: 1 dB or less, ±3 dB or less, or ±5% or less.

Although a method was described for acquiring correction circuit models (113-1-113-5) for correcting the board-mounted state in the present embodiment as an example of the power-supply system impedance, the acquisition of correction circuit models (113-6-113-10) for correcting the influence of uncoupled current can be executed by the same method by replacing the power-supply system impedance by the signal system impedance.

In the present embodiment, it was assumed that correction circuit models 113 that were acquired in the processes described in FIG. 15 were converted to a database to construct correction circuit library 112. However, the processes described in FIG. 15 may be made Step S102 and Step S103 in the design method of a semiconductor device or printed wiring board of FIG. 1, and semiconductor device model 116 into which correction circuit models 113 have been inserted and that was obtained by the processes described in FIG. 15 may be used as semiconductor device model 116 that is obtained as the processing result of Step S103.

According to the semiconductor device or printed wiring board design method and design support system of the present embodiment as described hereinabove, the design of a semiconductor device can be optimized through the use of semiconductor device model 116 that realizes high-accuracy correction of changes of electrical characteristics in a semiconductor package/printed wiring board in the mounted state. In addition, once semiconductor device models 116 in which changes of electrical characteristics in the board-mounted state have been corrected is produced, adjustment-object values can be calculated by connecting with adjustment-object system equivalent circuit network 117 that is obtained based on an adjustment-object system, and as a result, rechecking can be carried out easily and in a short time interval when a design is altered by, for example, adjusting the power-supply wiring length of the printed wiring board.

Still further, by means of semiconductor device model 116 into which correction circuit models 113 have been inserted and that is provided in the present embodiment, parasitic elements that occur when in a board-mounted state and that can not be expressed by the analysis model of a separate semiconductor device are inserted as correction parameters to enable expression, with high accuracy, of the state in which the semiconductor device is packaged on a substrate, and in addition, to enable appropriate assembly and use in accordance with the analysis object or purpose.

Although the present invention has been described concretely based on embodiments, the present invention is not limited to the form of the above-described embodiments and is open to various modifications that do not depart from the scope of the invention.

For example, although explanation in the present embodiment regarded an example in which devices that include a semiconductor package and printed wiring board were taken as the object of design, the concept of the present invention can also be applied to the design of a separate semiconductor package. In this case, correction circuit models 113 may be used for only those problems that originate in a semiconductor chip and semiconductor package. The package construction of a semiconductor package can be applied to various package constructions such as SiP (System in a Package), PoP (Package on a Package), and PiP (Package in Package).

The present embodiment included one combination of semiconductor device model 116 and adjustment-object system equivalent circuit network 117, but the concept of the present invention can also be similarly applied to a case in which there are a plurality of connected semiconductor device models 116 and adjustment-object system equivalent circuit networks 117. Although explanation in the present embodiment takes separate semiconductor device model 115 of an output circuit as its object, the concept of the present invention can be similarly applied to separate semiconductor device model 115 of an input circuit.

The present invention can be used in a semiconductor device or printed wiring board design method and in a design support system for supporting a design that accords with the design method.

It is apparent that the present invention is not limited to the above embodiments, but may be modified and changed without departing from the scope and spirit of the invention.

What is claimed is:

1. A semiconductor device or printed wiring board design method comprising:
acquiring correction circuit models for correcting electrical characteristic parameters of a semiconductor device or a printed wiring board that change according to parasitic elements that occur between said semiconductor device and said printed wiring board when said semiconductor device is mounted on said printed wiring board;
adding said acquired correction circuit models to a separate model that represents said separate semiconductor device to create a semiconductor device model that represents a semiconductor device that has been mounted on said printed wiring board;
connecting an equivalent circuit model that represents a predetermined adjustment-object system in said semiconductor device or said printed wiring board to said semiconductor device model that was created, and based on the semiconductor device model to which the equivalent circuit model is connected, calculating adjustment-object values that relate to the adjustment-object system; and
comparing said adjustment-object values that were calculated with limit values that are determined in advance, and based on the results of comparison, determining a design guide for adjusting said adjustment-object system.

2. The semiconductor device or printed wiring board design method according to claim 1, wherein:
said semiconductor device includes a semiconductor chip and a semiconductor package in which said semiconductor chip is mounted;
said adjustment-object system is parts of at least one of: power-supply wiring, ground wiring, and signal wiring of said semiconductor package and power-supply wiring, ground wiring, and signal wiring of said printed wiring board; and
said correction circuit models made up of at least of the following:
a model for correcting electrical characteristic parameters that change according to parasitic elements that occur between power-supply wiring of said semiconductor chip and power-supply wiring of said semiconductor package or said printed wiring board;
a model for correcting electrical characteristic parameters that change according to parasitic elements that occur between ground wiring of said semiconductor chip and ground wiring of said semiconductor package or said printed wiring board;
a model for correcting electrical characteristic parameters that change according to parasitic elements that occur in power-supply wiring and ground wiring of said semiconductor package and said printed wiring board;
a model for correcting electrical characteristic parameters that change according to parasitic elements that occur between power-supply wiring of said semiconductor package and power-supply wiring of said printed wiring board;
a model for correcting electrical characteristic parameters that change according to parasitic elements that occur between ground wiring of said semiconductor package and ground wiring of said printed wiring board;
a model for correcting electrical characteristic parameters that change according to parasitic elements that occur in power-supply wiring of said semiconductor package and/or said printed wiring board due to uncoupled current that occurs between signal current that is supplied from said semiconductor chip and the return current of said signal current;
a model for correcting electrical characteristic parameters that change according to parasitic elements that occur in signal wiring of said semiconductor package and/or said printed wiring board due to said uncoupled current;
a model for correcting electrical characteristic parameters that change according to parasitic elements that occur in ground wiring of said semiconductor package and/or said printed wiring board due to said uncoupled current;
a model for correcting electrical characteristic parameters that change according to parasitic elements that occur between signal wiring of said semiconductor package and power-supply wiring of said printed wiring board; and
a model for correcting electrical characteristic parameters that change according to parasitic elements that occur between signal wiring of said semiconductor package and ground wiring of said printed wiring board.

3. The semiconductor device or printed wiring board design method according to claim 1, wherein:
said semiconductor device includes a semiconductor chip and a semiconductor package to which said semiconductor chip is connected;
said adjustment-object system is parts of at least one of: power-supply wiring, ground wiring, and signal wiring of said semiconductor package and power-supply wiring, ground wiring, and signal wiring of said printed wiring board; and
said correction circuit models are made up of least one of: the following
a model for correcting electrical characteristic parameters that change according to parasitic elements that occur between power-supply wiring of said semiconductor chip and power-supply wiring of said semiconductor package or said printed wiring board;
a model for correcting electrical characteristic parameters that change according to parasitic elements that occur between ground wiring of said semiconductor chip and ground wiring of said semiconductor package or said printed wiring board;
a model for correcting electrical characteristic parameters that change according to parasitic elements that occur in power-supply wiring and ground wiring of said semiconductor package and said printed wiring board;
a model for correcting electrical characteristic parameters that change according to parasitic elements that occur between power-supply wiring of said semiconductor package and power-supply wiring of said printed wiring board; and
a model for correcting electrical characteristic parameters that change according to parasitic elements that occur between ground wiring of said semiconductor package and ground wiring of said printed wiring board.

4. The semiconductor device or printed wiring board design method according to claim 1, wherein:
said semiconductor device includes a semiconductor chip and a semiconductor package to which said semiconductor chip is connected;
said adjustment-object system is parts of at least one of: power-supply wiring, ground wiring, and signal wiring of said semiconductor package and power-supply wiring, ground wiring, and signal wiring of said printed wiring board; and
said correction circuit models are made up of least one of the following:
a model for correcting electrical characteristic parameters that change according to parasitic elements that occur in power-supply wiring of said semiconductor package and/or said printed wiring board due to uncoupled current that occurs between signal current that is supplied from said semiconductor chip and the return current of said signal current;
a model for correcting electrical characteristic parameters that change according to parasitic elements that occur in signal wiring of said semiconductor package and/or said printed wiring board due to said uncoupled current;
a model for correcting electrical characteristic parameters that change according to parasitic elements that occur in ground wiring of said semiconductor package and/or said printed wiring board due to said uncoupled current;
a model for correcting electrical characteristic parameters that change according to parasitic elements that occur between signal wiring of said semiconductor package and power-supply wiring of said printed wiring board; and
a model for correcting electrical characteristic parameters that change according to parasitic elements that occur between signal wiring of said semiconductor package and ground wiring of said printed wiring board.

5. The semiconductor device or printed wiring board design method according to claim 1, wherein:
said semiconductor device includes a semiconductor chip and a semiconductor package to which said semiconductor chip is connected;
said adjustment-object system is parts of at least one of: power-supply wiring, ground wiring, and signal wiring of said semiconductor package and power-supply wiring, ground wiring, and signal wiring of said printed wiring board; and
said correction circuit models are made up at least one of the following:
a model for correcting electrical characteristic parameters that change according to parasitic elements that occur between power-supply wiring of a core circuit of said semiconductor chip and power-supply wiring of said semiconductor package or said printed wiring board;
a model for correcting electrical characteristic parameters that change according to parasitic elements that occur between ground wiring of a core circuit of said semiconductor chip and ground wiring of said semiconductor package or said printed wiring board;
a model for correcting electrical characteristic parameters that change according to parasitic elements that occur in power-supply wiring and ground wiring of said semiconductor package and said printed wiring board;
a model for correcting electrical characteristic parameters that change according to parasitic elements that occur between power-supply wiring of said semiconductor package and power-supply wiring of said printed wiring board; and
a model for correcting electrical characteristic parameters that change according to parasitic elements that occur between ground wiring of said semiconductor package and ground wiring of said printed wiring board.

6. A design system comprising:
a memory unit for storing a correction circuit library that indicates, for each condition of a printed wiring board, correction circuit models for correcting electrical characteristic parameters of a semiconductor device or said printed wiring board that change according to parasitic elements that occur between said semiconductor device and said printed wiring board when said semiconductor device is mounted on said printed wiring board; and
an arithmetic unit for, according to conditions of said printed wiring board on which said semiconductor device is mounted, acquiring correction circuit models from a correction circuit library that is stored in said memory unit, adding said correction circuit models that were acquired to a separate model that represents said semiconductor device in isolation to create a semiconductor device model that represents the semiconductor device mounted on said printed wiring board, connecting to said semiconductor device model that was created an equivalent circuit model that represents an adjustment-object system in said semiconductor device or said printed wiring board that was determined in advance, calculating adjustment-object values relating to the adjustment-object system based on the semiconductor device model to which the equivalent circuit model is connected, comparing said adjustment-object values that were calculated with limit values that were determined in advance, and based on the comparison results, determining a design guide for adjusting said adjustment-object system.
